(19) United States
(12) Patent Application Publication
(10) Pub. No.: US 2001/0049710 A1
(43) Pub. Date: Dec. 6, 2001

(54) Partitioned executive structure for real-time programs

(76) Inventors: Randall K. Curey, Winnetka, CA (US); Daniel A. Tazartes, West Hills, CA (US); Kent T. Banno, Reseda, CA (US); John G. Mark, Pasadena, CA (US)

Correspondence Address: ROBERT E MALM, 16624 PEQUENO PLACE, PACIFIC PALISADES, CA, 90272

(21) Appl. No.: 09/821,537

(22) Filed: Mar. 28, 2001

Related U.S. Application Data
(63) Continuation-in-part of application No. 09/572,298, filed on May 16, 2000.

(51) Int. Cl. G06F 9/00

(52) U.S. Cl. 709/100; 709/102

(57) ABSTRACT

The invention is a method and apparatus for repetitively executing a plurality of software packages at a plurality of rates utilizing a common set of computational resources. The method consists of counting contiguous time increments and executing a plurality of software packages. Each software package is executed during each time increment in one or more sequences of time increments. The time increments in each sequence recur at a predetermined rate, and the time increments assigned to one software package do not overlap the time increments assigned to any other of the plurality of software packages.

### CROSS-REFERENCE TO RELATED APPLICATIONS

This is a continuation-in-part of application Ser. No. 09/572,298, filed May 16, 2000.

### STATEMENT REGARDING FEDERALLY SPONSORED RESEARCH AND DEVELOPMENT

(Not applicable)

### BACKGROUND OF THE INVENTION

This invention relates generally to real-time computer systems and more specifically to the software structure for such systems.

The control and operation of real-time computer systems typically require a communications software package to control the communications with external data sources and sinks, a database software package for controlling the storage, retrieval, and updating of system data, a transaction software package for controlling the execution of one or more applications, and an operating system that exercises overall control of the individual software packages.

In the past, one of the problems that has hampered missionization or customization of software is the competition for computer throughput. Generally, in the case of embedded real-time software in an inertial navigation system for example, one portion of the software is common (and usually essential) to all applications while additional portions are added or customized to satisfy specific applications. If the common and custom software execute in the same processor, there will be an inevitable competition for throughput resources.

The operating system together with a system of priorities provides a solution to this problem in many instances. Another approach replaces the operating system with a means for software partitioning. Software partitioning provides a means for avoiding interaction between different portions of the software. However, the partitioning methods to date rely on an accurate accounting for the amount of time required to execute different tasks. If execution times differ from the plan, one task might “step” on another leading to potentially catastrophic consequences. This is particularly a concern if a user designs and programs customized software to coexist with the essential common software.

### BRIEF SUMMARY OF THE INVENTION

The invention is a method and apparatus for repetitively executing a plurality of software packages at a plurality of rates utilizing a common set of computational resources. The method consists of counting contiguous time increments and executing a plurality of software packages. Each software package is executed during each time increment in one or more sequences of time increments. The time increments in each sequence recur at a predetermined rate, and the time increments assigned to one software package do not overlap the time increments assigned to any other of the plurality of software packages.

The method includes the case where a time increment is a sub-slot of a time slot, a time slot containing a plurality of sub-slots. In this case, one and only one software package is assigned to a sub-slot for execution. A software package can be programmed to execute during any number of sub-slots in a time slot. A software package can also be programmed to execute at two or more rates.

### BRIEF DESCRIPTION OF THE DRAWINGS

FIG. 1 shows an example of a set of timing signals and how they define time slots.

FIG. 2 shows the partitioned executive structure for the real-time program associated with an inertial navigation system.

FIG. 3 shows how software can be partitioned to execute at three rates.

FIG. 4 shows an example of memory allocation.

FIG. 5 shows an example of sharing data among partitions.

### DETAILED DESCRIPTION OF THE INVENTION

The invention is a time-partitioning arrangement that avoids the inflexibility of prior time-partitioning schemes. The invention will be described in reference to an inertial navigation system. However, it should be recognized that it applies to any similar embedded, realtime software application.

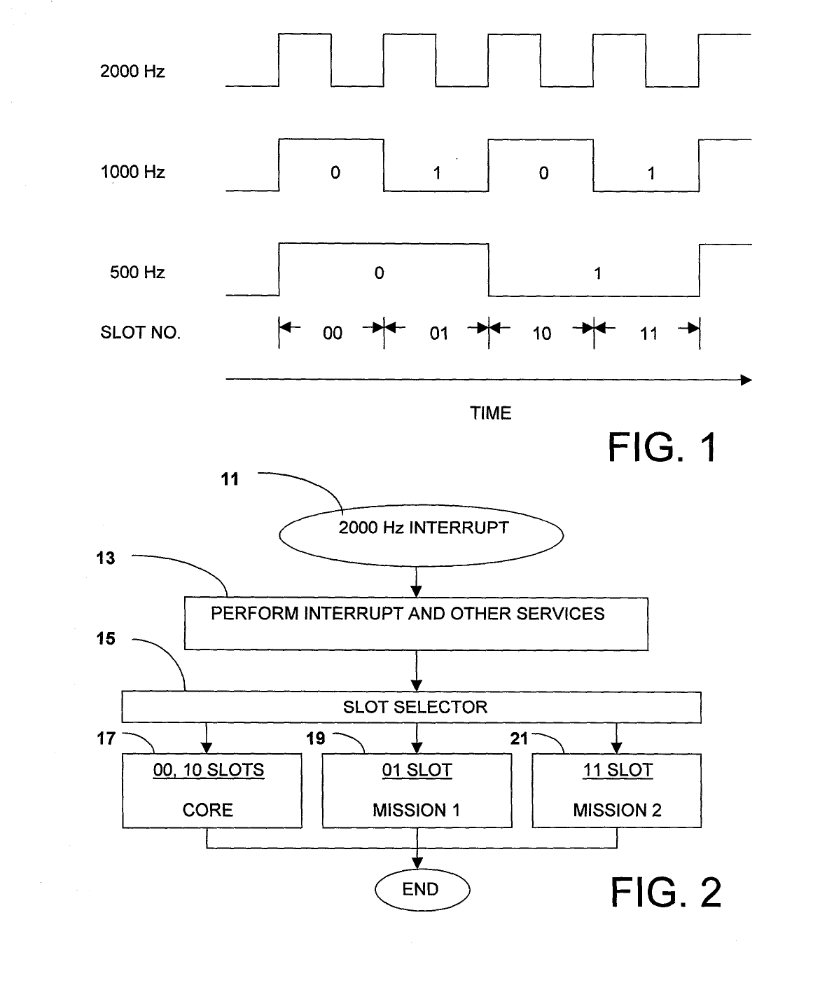

The partitioning arrangement is based on time slots 00, 01, 10, and 11 determined by 1000-Hz and 500-Hz clock signals derived from a 2000-Hz signal, as shown in FIG. 1.

The computer system software is driven from a 2000-Hz hardware interrupt 11 as shown in FIG. 2. At this 2000-Hz rate, several essential tasks are performed 13 such as interrupt servicing, reading of inertial data, etc. The selection of the next software package for execution is accomplished by slot selector 15 based on the time slot.

The execution of the core software package 17 occurs during time slots 00 and 10 at a rate of 1000 Hz. The core package includes data compensation procedures and the common essential procedures associated with the inertial measurement unit and navigation. The core package can also include the execution of strapdown algorithms at a rate of 500 Hz using either time slot 00 or time slot 10 or a combination thereof. Time slot 01 is reserved for the execution 19 of the mission 1 software package. Time slot 11 is reserved for the execution 21 of the mission 2 software package. One of the mission partitions 19 or 21 could equally well be allocated to user software. The different time slots can be assigned in arbitrary combinations. For example, time slots 00 and 01 could be assigned to core functions and time slots 10 and 11 could be assigned to mission functions.

This partitioning arrangement will not permit mission or user software to take time away from core software. The implementation of this partitioning arrangement, together with appropriate memory protection which many processors support, ensures independence in the execution of mission and core functions. Mission changes will not affect core software thereby avoiding costly fine-tuning of execution time allocation and regression testing. With this partitioning approach, user software can also implement its own executive within its allocated time window thereby avoiding the need for priority sharing with core and mission software.

In order to execute tasks at lower rates in each partition, each time slot may have its own scheduler that will divide the basic rate at which the partition is called by the appropriate factors in order to schedule the lower-rate tasks belonging to that particular partition. For example, referring to FIGS. 1 and 2, a 100-Hz task belonging to the core partition could be called every fifth time slot 00. Similarly, a 100-Hz task belonging to the Mission 1 partition could be called every fifth time slot 01. Because these 100-Hz tasks are guaranteed to occur in different time slots, there is no possibility of the Mission 1 100-Hz task interfering with the core 100-Hz task and vice versa. This approach can be implemented for any number of rates which can be subdivided from the basic 500-Hz rate which is the maximum rate at which any particular time slot can be activated in FIGS. 1 and 2. It should be noted however that the approach shown in FIGS. 1 and 2 is derived from a basic 2,000-Hz clock. Other frequencies are possible as appropriate. Furthermore, four time slots are shown with equal durations. It is also possible using a set of timers to implement the time slot partition with unequal durations. It is also possible to subdivide a basic repeating interval into any number of time slots using timers. The optimum design should be based on the specific requirements and a tradeoff between simplicity and low overhead on the one hand and additional flexibility on the other.

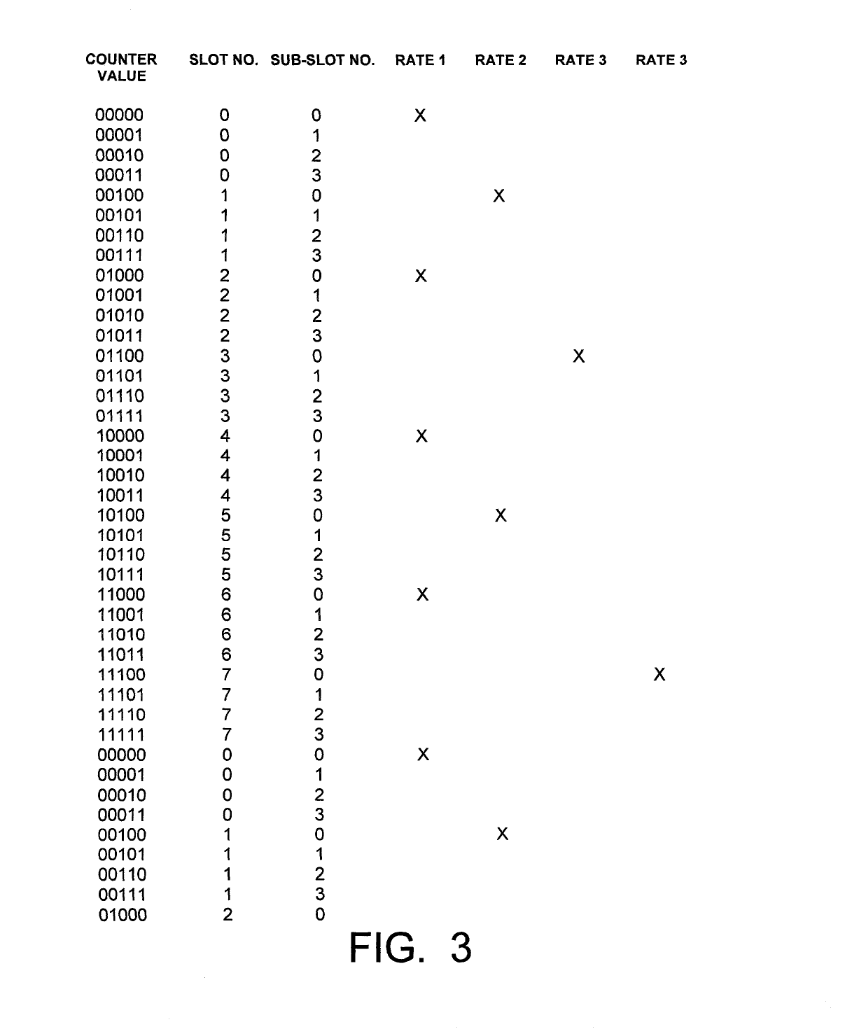

An expanded version of the invention is shown in FIG. 3. The positive transitions of a clock signal are counted in a five-bit counter. The counter values repeat after every 32 clock transitions. Time is divided into slots that are assigned numbers in accordance with the three most significant bits of the counter value. Each slot is divided into four sub-slots that are assigned numbers in accordance with the two least significant bits of the counter value.

If the execution of a software package is triggered when the least significant bit of the slot number equals 0 and the sub-slot number equals 0, the execution will occur at Rate 1 as indicated in FIG. 3 by the X's under the Rate 1 heading. A total of four software packages can be executed at Rate 1 by enabling the execution of the software packages in different sub-slots. If only one software package is to be executed at Rate 1, all of the sub-slots in the assigned slots can be utilized for the execution of the software package.

If two software packages are to be executed at Rate 1, each package could be assigned two sub-slots for execution or one might be assigned one sub-slot and the other might be assigned three sub-slots.

If the execution of a software package is triggered when the two least significant bits of the slot number equals 01 and the sub-slot number equals 0, the execution will occur at Rate 2 as indicated in FIG. 3 by the X's under the Rate 2 heading. Here also, four software packages can be executed at Rate 2 by taking advantage of the sub-slots associated with the assigned slots.

If the execution of a software package is triggered when the the three least significant bits of the slot number equals either 011 or 111 and the sub-slot number equals 0, the execution will occur at Rate 3 as indicated in FIG. 3 by the X's uner the Rate 3 headings. Here too, four software packages can be executed at Rate 3 in either Rate-3 mode by taking advantage of the sub-slots associated with the assigned slots.

A software package can be executed at rates other than those provided by Rate 1, Rate 2, and Rate 3 individually by combining the rates. The rate achieved with a Rate-2 execution doubles the rate of a Rate-3 execution. The rate achieved with a combination of Rate-2 and Rate-3 executions triples the rate of a Rate-3 execution. The rate achieved with a Rate-1 execution quadruples the rate of a Rate-3 execution. The rate achieved with the combination of Rate-1 and Rate-3 executions increases by fivefold the rate of a Rate-3 execution. The rate achieved with the combination of Rate-1 and Rate-2 executions increases by sixfold the rate of a Rate-3 execution. The rate achieved with the combination of Rate-1, Rate-2, and Rate-3 executions increases by sevenfold the rate of a Rate-3 execution. And finally, the rate achieved with the combination of Rate-1, Rate-2, and two Rate-3 executions increases by eightfold the rate of a Rate-3 execution.

Two software packages can be alternately assigned to a Rate-X slot and thereby executed at Rate (X+1). Or P software packages can assigned in sequence to a Rate-X slot and thereby executed at Rate X divided by P.

It should be clear from FIG. 3 that the resources necessary to execute each software package is exclusively available to each software package by the prescribed assignment of slots and sub-slots to the software packages to be executed.

The slot numbers S_{N} for execution of Rate N software packages are defined by the equation

S_{N} modulo 2^{N}=2^{N-1}−1 (1)

If Nmax is the highest Rate number to be used, then the second set of slot numbers S_{Nmax2} for execution of Rate Nmax software packages are defined by the equation

S_{Nmax2} modulo 2^{Nmax}=2^{Nmax}−1 (2)

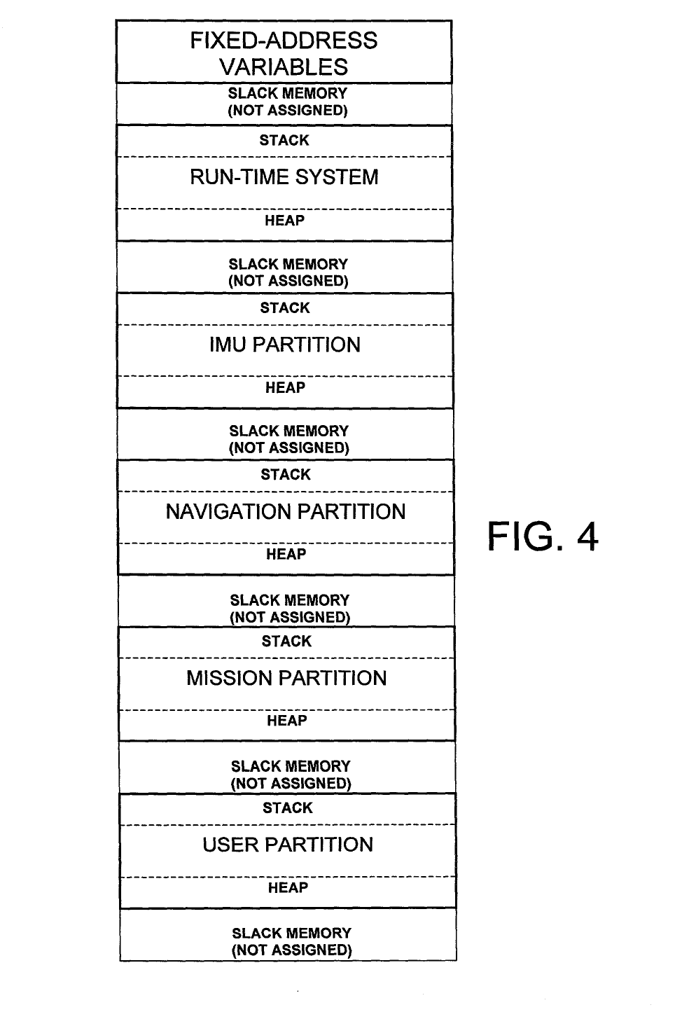

In accordance with the present invention a run-time system and each of a plurality of time/function partitions can have their own dedicated memory (which includes the stack and heap) as shown in FIG. 4. “Slack” memory, memory that is not assigned, is provided between the run-time system and each of the time/function partition's memory regions which are identified in the figure as the run-time system, the IMU partition, the navigation partition, the mission partition, and the user partition. However, the invention is applicable to any type of partitioning that a user might envision. The slack memory regions are denoted in FIG. 4 by the unlabeled regions between double lines. The purpose of the slack memory is to increase the probability of detecting a stack overflow before another software module's memory is corrupted.

An additional region of memory is dedicated to passing of data from one partition to one or more other partitions. This region consists of fixed-address variable blocks which contain data that is related functionally.

In the embodiment shown in FIG. 4, each of the dedicated regions of memory consists of multiple 4096-byte blocks of data. The 4096 byte block size was chosen so as to be compatible with the memory protection architecture of a Motorola PowerPC™ microprocessor.

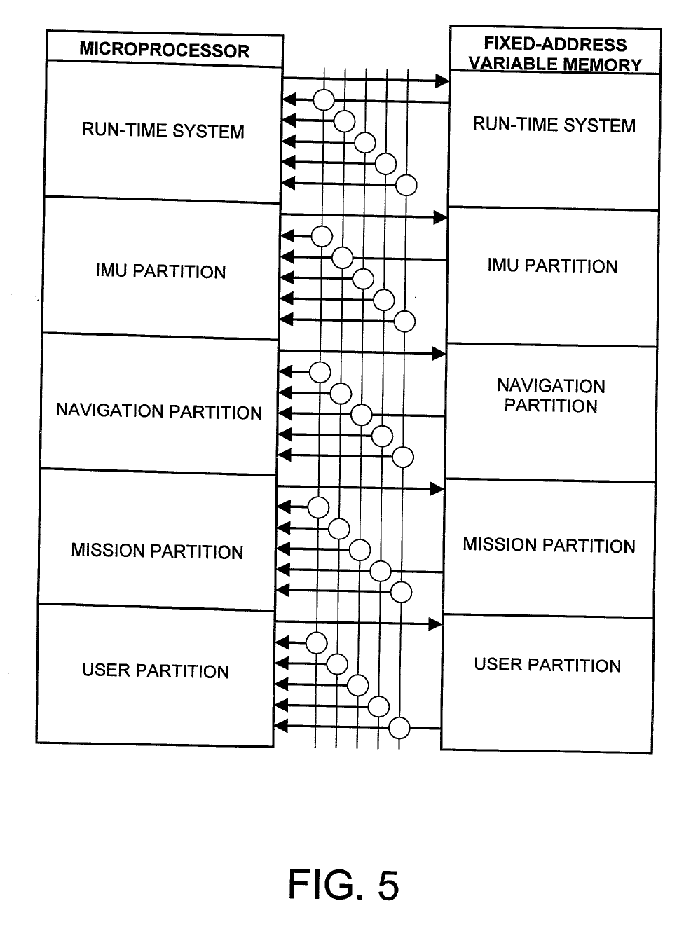

Data is shared between the run-time system and each of the time/function partitions via the dedicated fixed-address variable region of memory as shown symbolically by the arrows in FIG. 5. The circles denote connections to the vertical symbolic bus lines. As indicated by the arrows running from the microprocessor to memory, the microprocessor when executing a software package can write only into those blocks of memory which are assigned to that software package. As indicated by the arrows running from memory to the microprocessor, the microprocessor can read from any of the blocks of memory when executing any of the software packages.

The “read” accessibility of the different blocks of memory by the microprocessor when executing a particular software package may be more restrictive than that shown in FIG. 5. For example, if all the bus connection circles were removed, the microprocessor could read only from the memory block assigned to the software package being executed by the microprocessor. By properly choosing which “read” arrows associated with a particular software package are connected to bus lines, one can restrict memory access by the microprocessor while executing that software package to one or more of the memory blocks associated with other software packages in addition to its own.

The scheme illustrated in FIG. 5 assumes that the microprocessor can only write to the blocks of memory assigned to the software package which the microprocessor is executing. By providing “write” bus lines that are connectable to the “write” arrows, one can achieve the same flexibility in “writing” to memory as one can have in “reading” from memory.

It should be emphasized that the multiple “read” lines and the “read” bus lines are purely a symbolic way of defining the accessibility of the memory blocks to the microprocessor when the microprocessor is executing a particular software package. The actual procedure for accomplishing the specified accessiblity would be to incorporate the desired functional behavior within the individual software packages or by implementing memory protection.

The individual memory blocks act as unidirectional conduits for passing data from one partition to one or more other partitions. This permits outputting data or receiving required inputs from the pre-determined memory regions without knowledge of who is actually reading or providing the data. This makes the partitions highly decoupled from one-another.

Since dedicated memory is allocated for each partition's stack, heap, local variables, and program memory, the partitions can be independently compiled, linked and loaded. These independent loads allow developers to change one partition, re-compile and re-link that partition, and then re-load it without requiring re-compilation or re-linking of unmodified partitions.

The method for memory allocation and data interchange is designed to be compatible with memory protection. When such memory protection is activated, the partitioned software restricts memory accesses across partitions to ensure that no software partition can do damage to another. Inter-partition communication is handled through pre-assigned memory blocks with appropriate read/write privileges. When memory protection is activated, unauthorized memory accesses will be detected. Furthermore, the partition responsible for initiating the unauthorized access can be flagged as part of a failure detection and isolation process.

The partitioned executive structure provides one or more pre-allocated sequences of non-overlapping time slots for each of the partitions. The advantage of this approach is that it prevents the operation of one partition from overlapping onto another partition's allocated execution time. The scheme is based on a system interrupt which effects the switch from the current partition time slot to the next time slot. However, in some instances, it is necessary to mask this system interrupt for brief periods to permit completion of uninterruptible tasks. In order to prevent any partition from inhibiting interrupts for an extended period of time (longer than its allocated time), a protected hardware timer with a non-maskable interrupt is used to recover from this condition and potentially shut down the “culprit” partition. The protected hardware timer is accessible only by the partitioned executive, not the partitions, hence it is impossible for any partition to illegally allocate itself more time.

In order to make the system highly flexible, the partitioned executive is designed to automatically detect the presence of a valid partition. If a valid partition is present, the partitioned executive executes it in its predetermined time slot. In order to determine the validity of a partition, several tests are performed. The first step is a one's complement checksum test of the partition's program memory. The second step is a check on the address returned for the partition's initialization procedure to ensure that it lies within its dedicated memory space. The third step is a call of the initialization procedure followed by validity tests of the stack and heap memory ranges and the various entry points associated with the partition that were returned by the partitioned initialization procedure. Also, a timeout test is implemented on the procedures used to return the addresses for steps 2 and 3 to make sure that they complete within a predetermined time. Once the automatic detection is completed, an indication is provided as to the validity or invalidity of that partition.

In order to prevent a single partition from corrupting the stack used by the partitioned executive, each partition has its own stack. Prior to executing any code in a partition, that partition's stack is selected. The stack used at any given time will match the partition that is being executed at that time. One approach of handling the stack in this way is to allocate a buffer of stack pointers with one location for each partition as well as one for the partitioned executive itself. Upon transitioning between partitions, the current stack pointer is saved in the buffer location associated with the partition that is being exited and replaced with the contents of the buffer location associated with the partition being entered. This same process is used in transitions between the partitioned executive and any partition or vice versa. Another way of handling the stacks is to have an array of stack pointers and indirectly index into that array. The index specifies which stack is current.

In order to further emulate the operation of independent processors, each partition has its own background. The partitioned executive calls the appropriate partition background when that partition has completed its foreground tasks. The code in the background can be designed at the discretion of the partition's developer(s); for example, as an infinite loop, or as a procedure which when it returns relinquishes control to the partitioned executive's background. In this latter case, once the background tasks are completed, and control returns to the partitioned executive, it is possible to place the processor in a low power mode (if applicable).

The partitioned executive has the ability to isolate failures to the partition that caused them. For those classes of failures which generate interrupts, information is logged to allow the cause of the error to be easily pinpointed. The architecture permits each partition to have its own failure log. This makes it possible to assess whether one or more partitions should be shut down due to improper operation. A possible fault detection and evaluation scheme considers the number of failures and/or the rate of failures for certain classes of errors. The action to be taken and the thresholds are user-configurable in order to permit tailoring to specific safety requirements.

For safety-critical systems the invention can be used to isolate safety-critical software in one or more partitions which are highly decoupled from the other partitions. With memory protection enabled the other partitions cannot corrupt this safety-critical software. In addition, the time partitioning prevents the other partitions from interfering with the execution of the safety-critical software. Also, non-critical partitions which exhibit failures can be shut down while the safety-critical partitions can continue to operate normally.

What is claimed is:

1. A method for repetitively executing a plurality of software packages at one or more rates, utilizing a common set of computational resources, the method comprising the steps:
generating a sequence of time intervals for each of the plurality of software packages, the time intervals belonging to one software package not overlapping the time intervals belonging to any other of the plurality of software packages;
executing a plurality of software packages, each software package being executed during the time intervals of its sequence of time intervals.

2. The method of claim 1 wherein the plurality of software packages of the “executing” step includes only valid software packages, the method further comprising the step:
utilizing one or more tests to identify the software packages that are valid.

3. The method of claim 2 wherein one of the tests for validity is a one's complement checksum test of a software package's program memory.

4. The method of claim 2 wherein a software package is assigned its own dedicated memory region, one of the tests for validity being whether the address returned for the software package's initialization procedure lies within its dedicated memory region.

5. The method of claim 4 wherein one of the tests is whether the address is returned within a predetermined time.

6. The method of claim 2 wherein a software package is assigned its own dedicated memory region, the software package's dedicated memory region including a stack memory region and/or a heap memory region, one of the tests for validity being whether the stack memory range and/or the heap memory range assigned during the execution of the software package's initialization procedure and the various associated entry points lies within the software package's dedicated memory region.

7. The method of claim 6 wherein one of the tests is whether the stack memory range and/or the heap memory range and the various associated entry points are returned within a predetermined time.

8. The method of claim 1 wherein a software package is assigned its own dedicated memory region.

9. The method of claim 8 wherein the software package's dedicated memory region includes a stack memory region, a software package's stack residing in the software package's stack memory region.

10. The method of claim 1 wherein a software package includes background tasks as well as foreground tasks, the background tasks being performed after the foreground tasks have been completed.

11. The method of claim 10 wherein a background task is an infinite loop.

12. The method of claim 10 wherein the software package causes the power utilized in executing the software package to be minimized after completion of the background tasks.

13. The method of claim 1 wherein a failure in the execution of a software package causes information to be logged in a failure log.

14. The method of claim 13 wherein a failure in execution is linked to the software package that caused the failure.

15. The method of claim 13 wherein quality of performance in executing a software package is represented by one or more performance-quality parameters, values of the one or more performance-quality parameters being determined from the information logged in a failure log, the execution of a software package being subject to a plurality of execution options, an execution option being selected on the basis of one or more performance-quality parameter values.

16. The method of claim 15 wherein the plurality of execution options are user configurable.

17. The method of claim 15 wherein performance-quality parameters include the number of failures and/or the rate of failures for one or more classes of failures recorded in a software package's failure log.

18. The method of claim 1 wherein safety-critical software is placed in one or more separate partitions thereby isolating the safety-critical software from non-safety-critical software.

19. The method of claim 1 wherein each of the plurality of software packages is assigned its own memory block, a software package being enabled to read data only from zero or more memory blocks associated with other software packages, the zero or more memory blocks readable by a software package being either predetermined or determined during execution of the software packages in accordance with a set of one or more rules.

20. The method of claim 1 wherein each of the plurality of software packages is assigned its own memory block, a software package being enabled to write data only to zero or more memory blocks associated with other software packages, the zero or more memory blocks writeable by a software package being either predetermined or determined during execution of the software packages in accordance with a set of one or more rules.

21. The method of claim 1 wherein an executive software package enforces the discipline that each software package executes only during the time intervals of its sequence of time intervals, the executive software package determining when the execution of a software package extends into a time interval belonging to the sequence of time intervals assigned to another software package and performs a remedial action.

22. The method of claim 1 wherein the presence of those software packages that are present is detected.

23. The method of claim 1 wherein one or more of the plurality of software packages are independently compiled, linked, and loaded.

24. The method of claim 1 wherein a software package has its own stack, the software package's stack being selected prior to executing the software package.

25. Apparatus for practicing the method of claim 1.

26. Apparatus for repetitively executing a plurality of software packages at a plurality of rates, the apparatus comprising:
a means for generating a sequence of time intervals for each of the plurality of software packages, the time intervals belonging to one software package not overlapping the time intervals belonging to any other of the plurality of software packages;
a means for executing a plurality of software packages, each software package being executed during the time intervals of its sequence of time intervals.

27. The apparatus of claim 26 wherein the plurality of software packages executed by the “executing” means includes only valid software packages, the apparatus further comprising:
a means for utilizing one or more tests to identify the software packages that are valid.

28. The apparatus of claim 27 wherein one of the tests for validity is a one's complement checksum test of a software package's program memory.

29. The apparatus of claim 27 wherein a software package is assigned its own dedicated memory region, one of the tests for validity being whether the address returned for the software package's initialization procedure lies within its dedicated memory region.

30. The apparatus of claim 29 wherein one of the tests is whether the address is returned within a predetermined time.

31. The apparatus of claim 27 wherein a software package is assigned its own dedicated memory region, the software package's dedicated memory region including a stack memory region and/or a heap memory region, one of the tests for validity being whether the stack memory range and/or the heap memory range assigned during the execution of the software package's initialization procedure and the various associated entry points lies within the software package's dedicated memory region.

32. The apparatus of claim 31 wherein one of the tests is whether the stack memory range and/or the heap memory range and the various associated entry points are returned within a predetermined time.

33. The apparatus of claim 26 wherein a software package is assigned its own dedicated memory region.

34. The apparatus of claim 33 wherein the software package's dedicated memory region includes a stack memory region, a software package's stack residing in the software package's stack memory region.

35. The apparatus of claim 26 wherein a software package includes background tasks as well as foreground tasks, the background tasks being performed after the foreground tasks have been completed.

36. The apparatus of claim 35 wherein a background task is an infinite loop.

37. The apparatus of claim 35 wherein the software package causes the power utilized in executing the software package to be minimized after completion of the background tasks.

38. The apparatus of claim 26 wherein a failure in the execution of a software package causes information to be logged in a failure log.

39. The apparatus of claim 38 wherein a failure in execution is linked to the software package that caused the failure.

40. The apparatus of claim 38 wherein quality of performance in executing a software package is represented by one or more performance-quality parameters, values of the one or more performance-quality parameters being determined from the information logged in a failure log, the execution of a software package being subject to a plurality of execution options, an execution option being selected on the basis of one or more performance-quality parameter values.

41. The apparatus of claim 40 wherein the plurality of execution options are user configurable.

42. The apparatus of claim 40 wherein performance-quality parameters include the number of failures and/or the rate of failures for one or more classes of failures recorded in a software package's failure log.

43. The apparatus of claim 26 wherein safety-critical software is placed in one or more separate partitions thereby isolating the safety-critical software from non-safety-critical software.

44. The apparatus of claim 26 wherein each of the plurality of software packages is assigned its own memory block, a software package being enabled to read data only from zero or more memory blocks associated with other software packages, the zero or more memory blocks readable by a software package being either predetermined or determined during execution of the software packages in accordance with a set of one or more rules.

45. The apparatus of claim 26 wherein each of the plurality of software packages is assigned its own memory block, a software package being enabled to write data only to zero or more memory blocks associated with other software packages, the zero or more memory blocks writeable by a software package being either predetermined or determined during execution of the software packages in accordance with a set of one or more rules.

46. The apparatus of claim 26 wherein an executive software package enforces the discipline that each software package executes only during the time intervals of its sequence of time intervals, the executive software package determining when the execution of a software package extends into a time interval belonging to the sequence of time intervals assigned to another software package and performs a remedial action.

47. The apparatus of claim 26 wherein the presence of those software packages that are present is detected.

48. The apparatus of claim 26 wherein one or more of the plurality of software packages are independently compiled, linked, and loaded.

49. The apparatus of claim 26 wherein a software package has its own stack, the software package's stack being selected prior to executing the software package.
